(19) United States
(12) Patent Application Publication
(10) Pub. No.: US 2006/0214123 A1
(43) Pub. Date: Sep. 28, 2006

(54) Linear illumination using cylindrical elliptical reflective surface

(75) Inventor: Rongguang Liang, Penfield, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/089,497

(22) Filed: Mar. 24, 2005

(51) Int. Cl. G03B 42/08

(52) U.S. Cl. 250/585

(57) ABSTRACT

An illumination apparatus of an optical scanning system having at least one light source arranged along a first line and a cylindrical elliptical reflective surface substantially parallel to the first line for directing light from the at least one light source toward a scanned surface. The cylindrical elliptical reflective surface forms a line of light along the scanned surface.

### CROSS REFERENCE TO RELATED APPLICATIONS

Reference is made to commonly assigned application U.S. Ser. No. ______ (Kodak Docket No. 88938), entitled “LINEAR ILLUMINATION APPARATUS AND METHOD”, and filed on common date herewith in the name of Liang, and which is assigned to the assignee of this application.

### FIELD OF THE INVENTION

The present invention generally relates to imaging systems for reading images exposed on CR plates, and more particularly relates to an illumination apparatus for scanning line images from stimulable phosphor surfaces.

### BACKGROUND OF THE INVENTION

Computed Radiography (CR) systems using stimulable phosphor sheets are well known clinical imaging tools. In a CR system, radiation is passed through a subject and impinges upon a stimulable phosphor sheet, commonly referred to as a CR plate, phosphor plate, or CR sheet, that stores a portion of the radiation energy as a latent image. After exposure to the radiation, the stimulable phosphor on the CR plate is subsequently scanned using an excitation light, such as a visible light or laser beam, in order to emit the stored image.

Some CR scanning systems employ a flying-spot scanning mechanism, in which a single laser beam is scanned across the CR plate in a raster pattern. The resulting excitation that provides the stored image is then directed to a sensor, providing a single point of image data at a time. Other CR systems provide a full line of image data at a time, offering advantages of faster throughput and lower cost and complexity over flying-spot scanners. For example, U.S. Pat. No. 6,373,074 (Mueller et al.) entitled “Device for Reading Out Information Stored in a Phosphor-Carrier, and an X-Ray Cassette” is directed to a CR system that scans a full line of image data points at a time.

FIG. 1 shows components of a prior art optical scanning system 10. A linear light source 12, typically using an array of laser diodes or other light sources, directs a linear scanning beam 14 onto a stimulable phosphor sheet 16 that has been irradiated and stores a latent X-ray image. One or more cylindrical lenses 18 are used to direct the highly asymmetric linear output beam along a line 20 on the surface of phosphor sheet 16. In a sensing head 22, typically containing multiple channels, collection optics 24 then direct the stimulated light from line 20 on phosphor sheet 16 through an optical filter 26 and to a linear photodetector array 28, typically a CCD array. Phosphor sheet 16 is indexed in direction D by a transport mechanism 60, such as a continuous belt or other indexing apparatus, to provide a scanning motion. In this way, phosphor sheet 16 is scanned past sensing head 22 to detect each line of the image stored thereon. The sensed image data is then processed by an image processor 30 that assembles a two-dimensional output image from each successive sensed line. The output image can then be recorded onto a writable medium such as a photosensitive film, or can be displayed.

There have been a number of solutions proposed for improving the performance of CR plate scanner optics. Several examples are noted below.

U.S. Patent Application Publication No. 2003/0010945 entitled “Radiation Image Read-Out Apparatus” (Ishikawa) is directed to a light projection apparatus for projecting a line of stimulating light from an array of laser diodes.

U.S. Patent Application Publication No. 2002/0096653 entitled “Radiation Image Information Read-Out Apparatus” (Karasawa) relates to the use of condenser lens chromatic characteristics for isolating stimulated light from stimulating light provided from the array of laser diodes.

U.S. Patent Application Publication No. 2002/0056817 entitled “Radiation Image Information Reading Recording Apparatus” (Furue) is directed to a reading apparatus for obtaining the stored image from an irradiated stimulable phosphor sheet using an array of laser diodes.

U.S. Patent Application Publication No. 2002/0040972 entitled “Radiation Image Read-Out Method and Apparatus” (Arakawa) relates to an optical reading head using an array of laser diodes that employs a grid pattern for sensing each line of the stored image.

U.S. Patent Application Publication No. 2002/0100887 entitled “Radiation-Image Data Readout Apparatus and Line Sensor to be Utilized Therein” (Hagiwara et al.) relates to an improved sensing arrangement in a scanning head for a stimulable phosphor sheet.

U.S. Patent Application Publication No. 2001/0025936 entitled “Image Detecting Device and Readout Exposure Apparatus Therefore” (Shoji) is directed to an illumination apparatus using pairs of cylindrical lenses and a slit for conditioning light from an LED array or other linear array of light sources.

U.S. Patent Application Publication No. 2001/0028047 entitled “Radiation Image Read-Out Apparatus” (Isoda) relates to a system using conventional optical techniques with improvements to line sensor components for obtaining a larger percentage of the stimulated light.

U.S. Pat. No. 5,721,416 entitled “Optics for Forming a Sharp Illuminating Line of a Laser Beam” (Burghardt et al.) is directed to the use of a homogenizing optical system for conditioning a laser beam, such as a system that utilizes an arrangement of specially configured lens elements for spreading the incident laser beam over a broadened area, such as described in U.S. Pat. No. 5,414,559 (Burghardt et al.).

U.S. Patent Application Publication No. 2003/0128543 entitled “Apparatus for Projecting a Line of Light from a Diode-Laser Array” (Rekow) discloses an apparatus for forming a line of light from a diode laser bar, using an arrangement of anamorphic lenses, including cylindrical microlens arrays.

U.S. Pat. No. 6,565,248 entitled “Light Guide, Line Illumination Apparatus, and Image Acquisition System” (Honguh et al.) discloses a system using LED light sources and scattering marks arranged within a light guide, where the scattering marks are positioned near the focal point formed by an elliptical surface portion of the light guide, so that light is directed toward a surface to be scanned at a preferred angle.

U.S. Pat. No. 6,744,033 entitled “Bar-Shaped Light Guide, Line-Illuminating Device Incorporated with the Bar-Shaped Light Guide and Contact-Type Image Sensor Incorporated with the Line-Illuminating Device” (Ikeda) discloses an elliptically shaped illuminating light guide using scatterers for redirecting LED illumination, similar to that of the '248 Honguh et al. patent.

U.S. Pat. No. 4,598,738 entitled “Apparatus for Projecting a Laser Beam in a Linear Pattern” (Ozaki) relates to the use of a concave mirror for redirecting laser illumination that has been reflected from a convex reflector disposed in front of the mirror, forming a line of illumination thereby.

The approaches described in the above-cited patent literature provide some techniques for forming, from multiple laser sources such as an array of laser diodes, a line of illumination having reasonably uniform irradiance.

However, there is felt to be room for improvement. For example, the requirement for illuminating line widths on the order of 100-200 μm is difficult to achieve for Lambertian light sources such as those used in the apparatus of the '248 Honguh et al. and '033 Ikeda disclosures. Laser diodes would not be well suited to the apparatus of the '248 Honguh et al. and '033 Ikeda disclosures, since scattering effects with highly coherent light would be likely to cause speckle. The optical arrangement of the '738 Ozaki disclosure presents practical difficulties for optomechanical design, with an intermediate reflective structure that effectively blocks a portion of the available light, reducing light throughput and compromising uniformity. Conventional solutions using laser diode arrays and cylindrical lenses, such as those proposed in the '0972 Arakawa disclosure, are characterized by relatively poor uniformity of irradiance along the line of illumination provided and variable line widths at different points along the line. Solutions such as those shown in the '5936 Shoji and '0972 Arakawa disclosures are highly sensitive to laser diode faults or intensity differences between individual laser diode emitters, resulting in non-uniformity of irradiance.

Of particular interest are illumination solutions that utilize laser diodes but are inherently more robust and provide better uniformity than that of conventional illumination apparatus. Referring back to FIG. 1, light source 12 directs a narrow line of light onto stimulable phosphor sheet 16 as scanning beam 14. For obtaining high levels of image quality, scanning beam 14 must be of sufficient intensity and must be uniform over the length of the scan line. For suitable contrast, scanning beam 14 must also have sufficiently narrow width and sharp definition, so that only the line of the stored image that is currently being sensed is stimulated. At the same time, line 20 formed by scanning beam 14 needs uniform irradiance along its length.

Accordingly, there exists a need for an illumination apparatus that meets these requirements at relatively low cost and allows some flexibility for adjustment of the irradiance profile of the linear illumination formed.

### SUMMARY OF THE INVENTION

The present invention provides an illumination apparatus intended to overcome one or more of the disadvantages of the CR plate scanner optics noted above.

According to one aspect of the present invention, there is provided an illumination apparatus comprising: a) at least one light source arranged along a first line; and, b) a cylindrical elliptical reflective surface substantially parallel to the first line for directing light from the at least one light source toward a scanned surface, the cylindrical elliptical reflective surface forming a line of light along the scanned surface thereby.

The present invention employs laser diodes or other suitable point sources with an elliptical reflector element for providing a linear illumination. The present invention further provides a linear light of substantially uniform intensity particularly suited to scanning applications.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic block diagram showing the basic component arrangement of a conventional prior art CR plate reader.

FIG. 2 is a side view of an illumination apparatus according to the present invention.

FIG. 3 is a side view of an illumination apparatus according to the present invention, showing the optical behavior of the elliptical reflector from a cross-sectional perspective.

FIG. 4 is a schematic drawing showing optical behavior of an elliptical structure relative to a point source.

FIG. 5 is a perspective view showing how an cylindrical elliptical surface is defined and showing its focal lines.

FIG. 6 is a perspective view showing the path of light reflected from a cylindrical elliptical reflective surface in horizontal and vertical planes.

FIG. 7 is a perspective view showing the path of light reflected from a cylindrical elliptical reflective surface in horizontal and vertical planes, with light rays in the vertical plane shown by dashed lines.

FIG. 8 is a perspective view of an illumination apparatus according to the present invention.

FIG. 9 is a graph showing the irradiance profile of a line of illumination formed using the apparatus of the present invention.

FIG. 10 is a composite drawing showing a portion of a line of illumination formed and its cross-sectional irradiance profile.

FIG. 11 is a graph showing cross-sectional irradiance profiles for various spatial positioning of light emitting components.

### DETAILED DESCRIPTION OF THE INVENTION

The following is a detailed description of the preferred embodiments of the invention, reference being made to the drawings in which the same reference numerals identify the same elements of structure in each of the several figures.

The present description is directed in particular to elements forming part of, or cooperating more directly with, apparatus in accordance with the invention. It is to be understood that elements not specifically shown or described may take various forms well known to those skilled in the art.

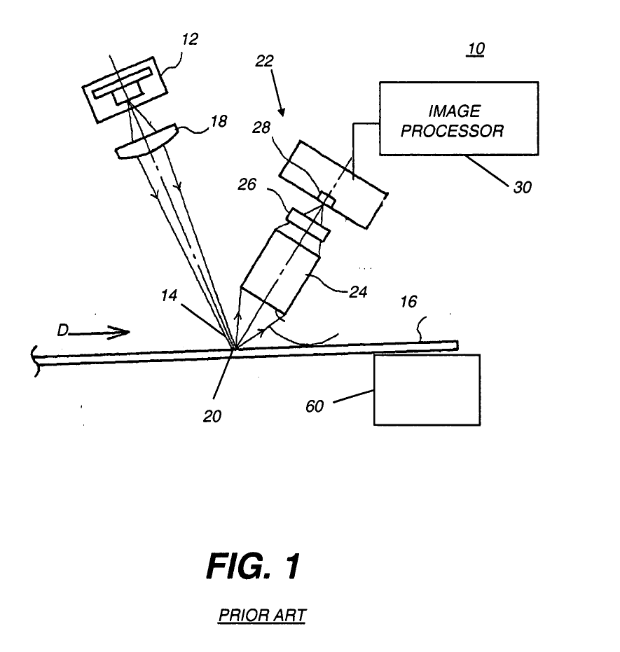

The present invention takes advantage of characteristics of a cylindrical elliptical reflective surface for directing illumination from a point source located at its focal point. To achieve high brightness levels with a minimum of components, the present invention adapts laser diode technology to provide point light sources that work together particularly well with light-directing characteristics of the cylindrical elliptical reflective surface. Using the apparatus and method of the present invention, a linear stimulating irradiation can be provided, such as would be used in optical scanning system 10 of FIG. 1 or other type of system.

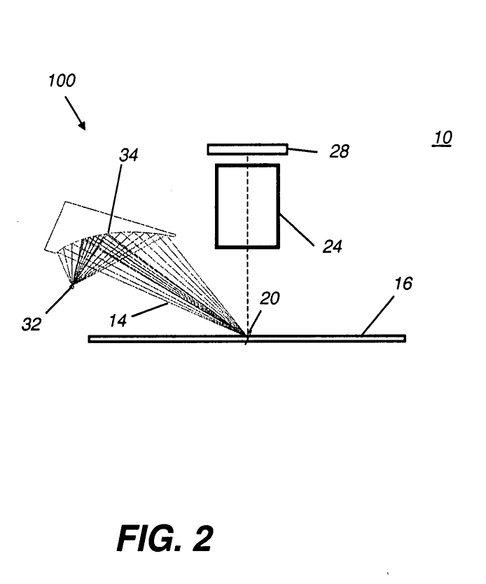

Referring to FIG. 2, there is shown a simplified schematic side view diagram of an illumination apparatus 100 in one embodiment of optical scanning system 10 according to the present invention. A point source 32, such as a laser diode or other source of substantially coherent radiation, directs light toward a cylindrical elliptical reflective surface 34. Cylindrical elliptical reflective surface 34 reflects this light to provide scanning beam 14 onto phosphor sheet 16 or other surface to be scanned. As was described with reference to FIG. 1, scanning beam 14 forms line 20 of light on the surface of phosphor sheet 16.

Illumination apparatus 100 co-operates with an arrangement of collection optics 24 to direct the resultant excitation light to photodetector array 28 for sensing the image segment corresponding to line 20. Collection optics 24 and photodetector array 28 typically provide multiple channels. Additional support apparatus shown in FIG. 1 for transporting phosphor sheet 16, for processing image data, and for further conditioning the detected light can also be used for optical scanning system 10 that employs illumination apparatus 100 of the present invention.

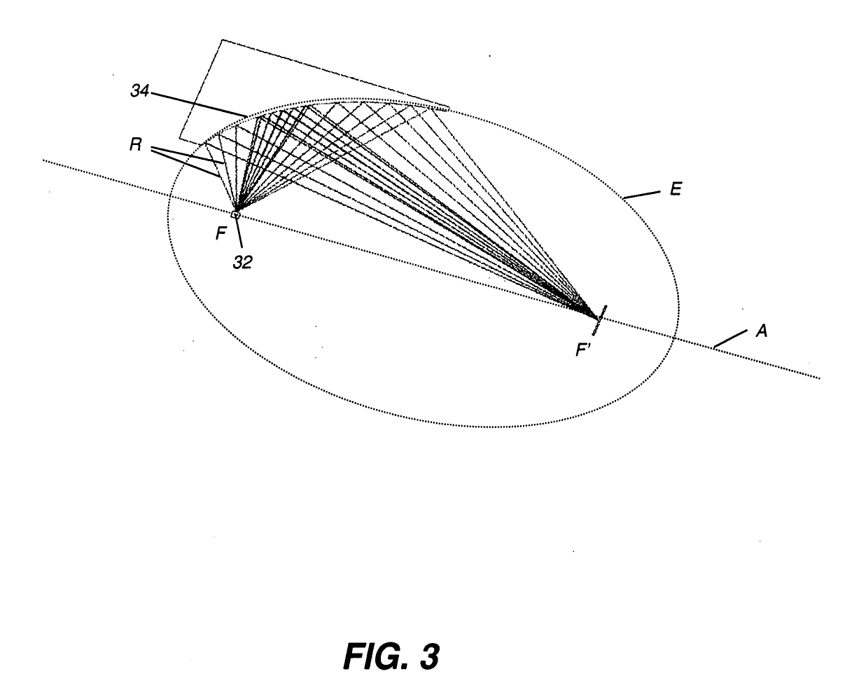

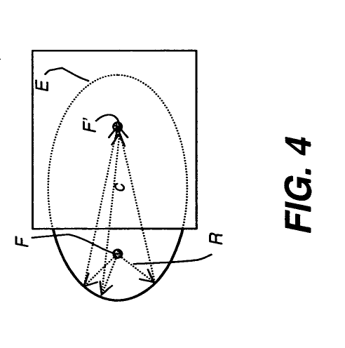

To more particularly understand the apparatus and method of the present invention and to establish some key definitions, a review of the handling of light by an elliptical structure is provided. Referring to FIG. 3, an ellipse E is traced in phantom over cylindrical elliptical reflective surface 34. From FIG. 3, it is clear that elliptical reflective surface 34 is, considered in the cross-sectional view of FIG. 3, a section of ellipse E, having two focal points, F and F′ that define an axis A. Point source 32 is located at focal point F and directs light toward cylindrical elliptical reflective surface 34. As is shown in the simplified two-dimensional diagram of FIG. 4, light rays R that are directed toward a reflective surface of ellipse E from focal point F, such as rays R directed toward cylindrical elliptical reflective surface 34, are reflected toward focal point F′.

The light handling behavior of cylindrical elliptical reflective surface 34 shown in FIGS. 3 and 4 applies in the two-dimensional, vertical plane. It is next instructive to consider the full, three-dimensional treatment of light given by cylindrical elliptical reflective surface 34.

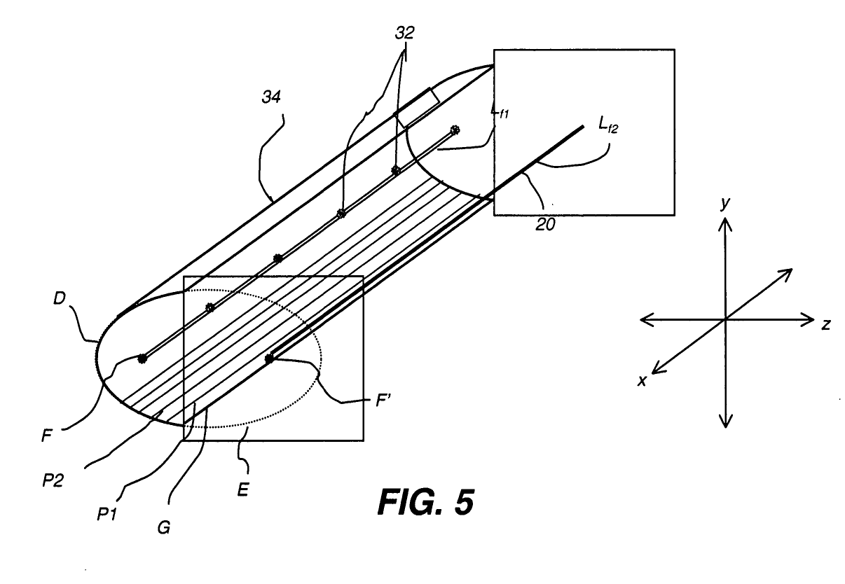

Referring first to FIG. 5, there is shown cylindrical elliptical reflective surface 34 as applied for directing light in the present invention. Following a generalized mathematical definition, a cylindrical surface is traced out by a line, termed the generatrix, moving parallel to itself and intersecting with a curve, termed the directrix, that defines the surface shape. For example, in FIG. 5, line G can be considered as the generatrix for parallel lines P1, P2 and following. A segment of ellipse E, shown as a continuous line in FIG. 5, acts as the directrix D. Cylindrical elliptical reflective surface 34 is, then, given the shape, when considered in the yz plane parallel to the page, of some segment of ellipse E. For the orientation of cylindrical elliptical reflective surface 34 used in the present invention, this yz plane can be considered the vertical plane.

A first focal line L_{f1} is defined along the length of cylindrical elliptical reflective surface 34 and is substantially parallel to cylindrical elliptical reflective surface 34. Using the two-dimensional approach given above, first focal line L_{f1} can be considered as the set of all focal points F closest to cylindrical elliptical reflective surface 34. One or more point sources 32 are arranged along first focal line L_{f1} to direct light toward cylindrical elliptical reflective surface 34. The reflected light from cylindrical elliptical reflective surface 34 then forms a line of illumination at a second focal line L_{f2} that is aligned with focal points F′ as shown. For the apparatus and method of the present invention, second focal line L_{f2} corresponds to line 20 in illumination apparatus 100 as described with reference to FIGS. 1 and 2.

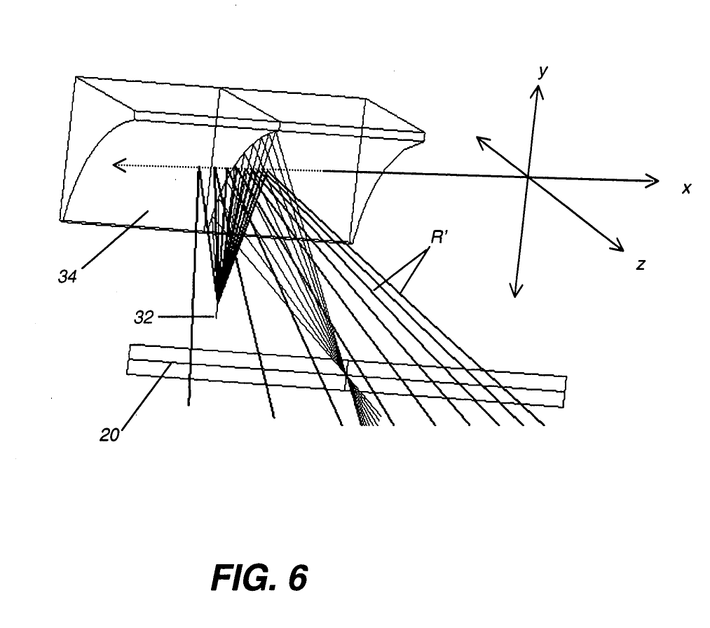

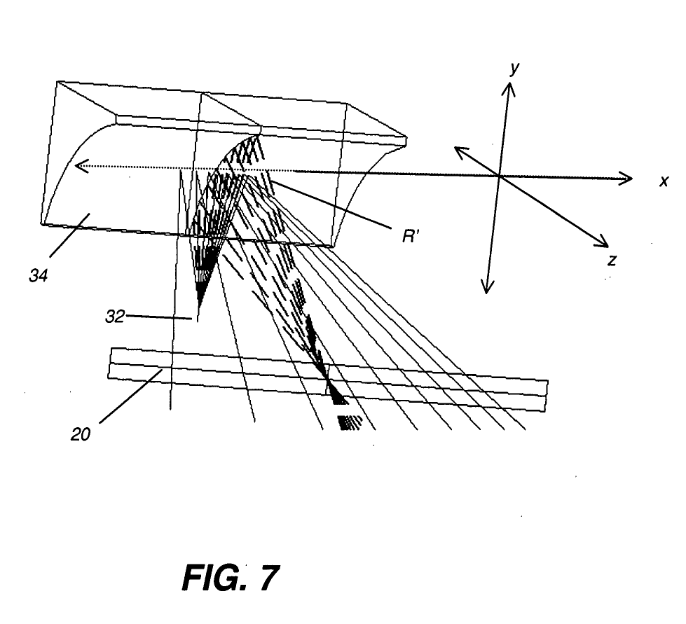

It is next instructive to describe how cylindrical elliptical reflective surface 34 forms line 20 from point sources 32. The perspective views of FIGS. 6 and 7 show how incident light is handled in both horizontal (xz) and vertical (yz) planes. Referring first to the horizontal direction, FIG. 6 shows the horizontal path of light, with reflected light rays R′ along this axis shown in bold.

Light from point source 32 diverges at some angle and is incident on cylindrical elliptical reflective surface 34. In this horizontal (xz) direction, cylindrical elliptical reflective surface 34 has no optical power, but simply reflects light as if it were a plane mirrored surface. That is, the divergent light incident at one angle is reflected at a substantially equal and opposite angle with respect to normal.

Hence, with respect to this plane, the reflected light from point source 32 is spread along line 20. By comparison with FIG. 6, FIG. 7 more particularly illustrates, using bold dashed lines for reflected light rays R′, the reflection of light by cylindrical elliptical reflective surface 34 in the vertical or yz plane. This handling was shown in two dimensions in FIGS. 3 and 4. As a cylindrical optical element, then, cylindrical elliptical reflective surface 34 has no optical power in the horizontal direction parallel to first focal line L_{f1} (FIG. 5) and has positive optical power in the vertical direction orthogonal to the first focal line L_{f1}.

As is shown in FIGS. 2, 6, and 7, the curvature provided to cylindrical elliptical reflective surface 34 in practice can be selected from any suitable segment of an ellipse. Because laser diodes, point sources 32 in one embodiment, are highly directional, only a small segment of surface having an elliptical curvature is needed in the embodiment shown.

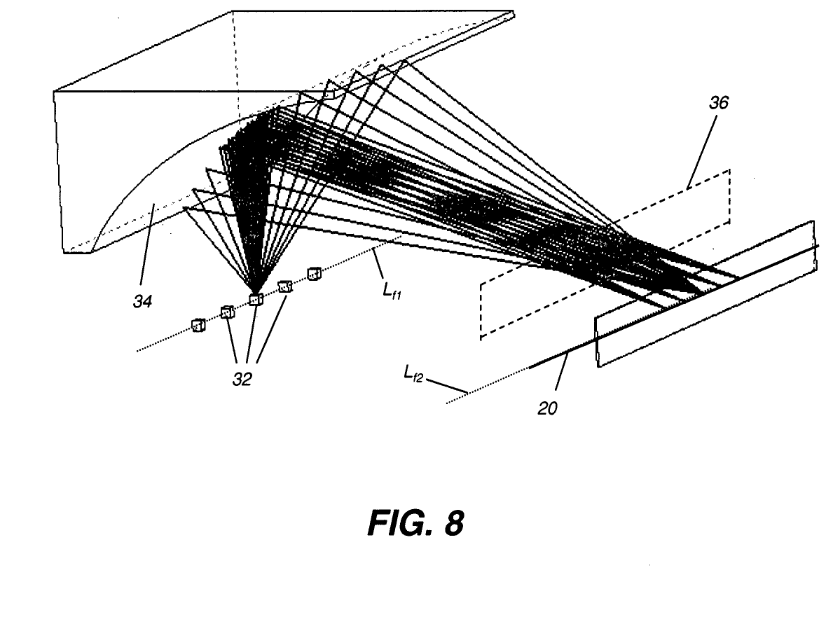

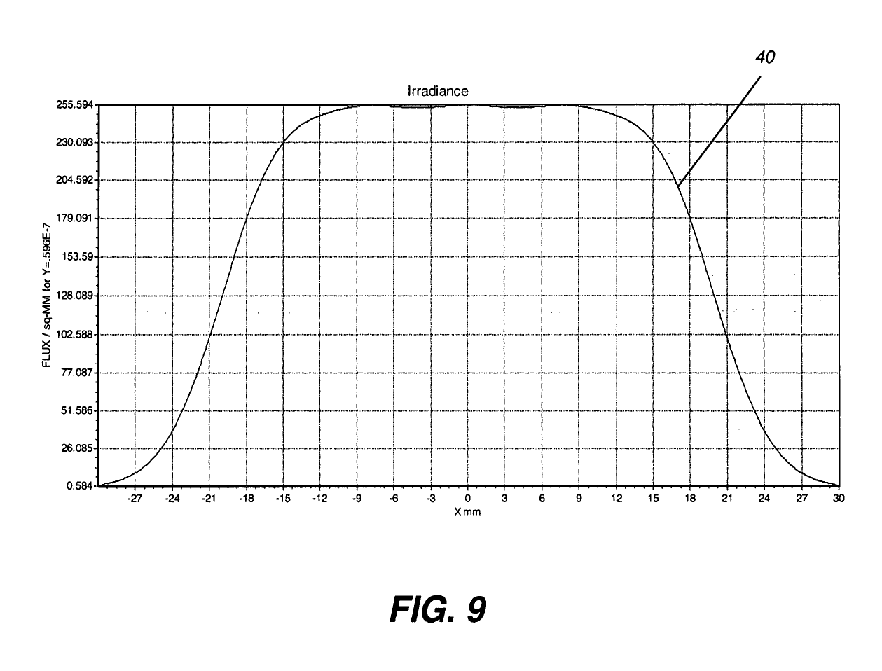

Referring now to FIG. 8, there is shown a perspective view of a portion of cylindrical elliptical reflective surface 34 with multiple point sources 32 arranged along first focal line L_{f1} as was defined with reference to FIG. 5. The number of point sources 32 used and their spacing along first focal line L_{f1} depends on a number of factors, including the relative divergence angle of light emission and the needed irradiance of illumination line 20. For one embodiment, the graph of FIG. 9 shows an irradiance curve 40 having relatively uniform light flux measurement obtained over the length of illumination line 20.

With respect to FIG. 9, it is instructive to note that, because scanning is typically performed using a pattern of partially overlapping swaths, outer portions of irradiance curve 40 correspond to overlapped portions; thus, areas receiving reduced irradiance levels are in the overlapped portion of the scanned swath and receive scanning light in two passes.

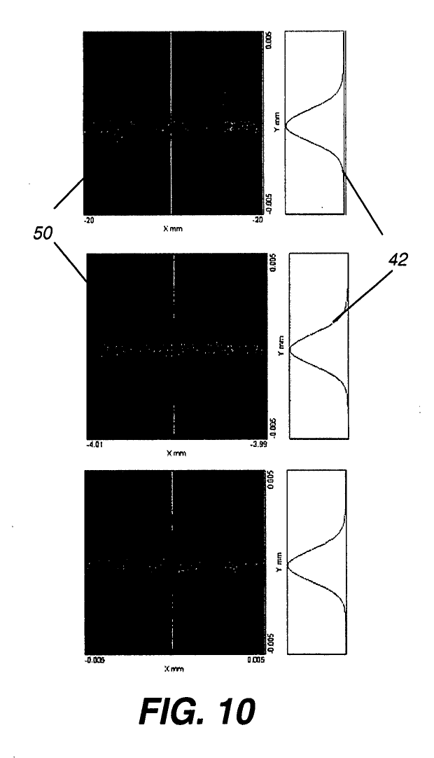

Uniform irradiance along the length of illumination line 20 is an important feature. In addition, the irradiance profile across line 20, that is, in the width dimension, is also of interest. FIG. 10 shows an irradiance pattern 50 and irradiance profile 42 taken at multiple locations across the width of line 20. Advantageously, irradiance profiles 42 taken at multiple points along the length of illumination line 20 show that the beam widths are the same at these different locations.

Irradiance profile 42 across line 20 can be adjusted to adjust the width of line 20 over a range of possible widths. This adjustment can be effected, for example, by moving the position of point sources 32 away from first focal line L_{f1}.

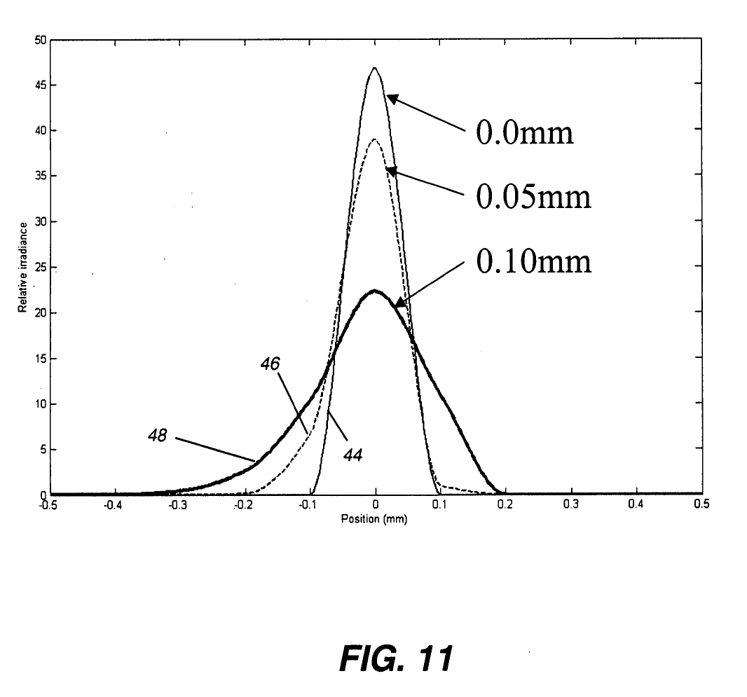

Referring to FIG. 11, there are shown irradiance profiles 44, 46, and 48 for point sources 32 located at different positions relative to first focal line L_{f1}. As determined by the geometry described with reference to FIG. 5, maximized irradiance and narrowest line width for line 20 is obtained with point sources 32 in line along first focal line L_{f1}, as shown by irradiance profile 44 in FIG. 11. Slight shifting of point sources to about 0.05 mm from first focal line L_{f1} thickens line 20 and reduces irradiance by a measurable increment, as shown by irradiance profile 46. Further broadening of line 20 width at the expense of irradiance levels results after shifting point sources 32 to about 0.10 mm from focus along first focal line L_{f1}, as shown by irradiance profile 48. Notably, however, shifting point sources away from focal line L_{f1} for some short distance, while it affects the irradiance profile across line 20, has only a negligible effect on uniformity of irradiance along line 20 (FIG. 9). Thus, the method of adjusting the position of point sources slightly away from first local line L_{1f} can be effectively used to adjust line 20 width without compromising irradiance uniformity along the length of line 20. However, it must be noted that the complete line of point sources 32 should be moved as a unit in order to maintain suitable uniformity along the length of line 20.

The present invention provides a narrow line width having highly uniform irradiance from point light sources such as laser diodes. Advantageously, the present invention allows some amount of overall irradiance adjustment, based on the power of point sources 32 and the spacing provided between them. Illumination apparatus 100, as shown and described in FIG. 2 and following can be used to provide scanning line 20 as a part of optical scanning system 10 of FIG. 1, providing the functions of light source 12 and lens 18 or other supporting optics, as described with reference to FIG. 1. Illumination apparatus 100 can be used in an apparatus having multiple channels for image sensing. Illumination apparatus 100 can also be used in some other type of apparatus requiring a narrow, intense, and uniform line of illumination.

The present invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

For example, while laser diodes or other sources of substantially coherent radiation are used to advantage as point sources 32 in one embodiment, other types of point sources, such as light emitting diodes (LEDs) for example, could alternately be used. An important factor in determining the suitability of an alternative type of point source 32 is the requirement for sharpness and power of the irradiance at line 20. Where sharpness of line 20 is less critical and power level of less importance, point sources 32 other than laser diodes may be acceptable. The radiation provided can be light radiation at visible or non-visible wavelengths. Cylindrical elliptical reflective surface 34 could have curvature adapted from any suitable segment of an ellipse. Materials used for fabrication of cylindrical elliptical reflective surface 34 could be plastic, glass, metal, or other materials and could be coated appropriately. Masks, apertures, filters, or other intervening components could be used for further shaping or conditioning of scanning beam 14, changing the irradiance profile accordingly. For example, as shown in phantom in FIG. 8, an optional absorption filter 36 can be interposed in the path of reflected light in order to change the irradiance profile of line 20.

Thus, the present invention provides an apparatus and method for forming a line of illumination from point light sources, having high irradiance and substantially uniform intensity.

All documents, articles, patents, patent applications, and other referenced items are incorporated herein in by reference.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10. Optical scanning system
12. Light source
14. Scanning beam
16. Phosphor sheet
18. Lens
20. Line
22. Sensing head
24. Collection optics
26. Optical filter
28. Photodetector array
30. Image processor
32. Point source
34. Cylindrical elliptical reflective surface
36. Filter
40. Curve
42, 44, 46, 48. Irradiance profile
50. Irradiance pattern
60. Transport mechanism
100. Illumination apparatus
A. Axis
D. Directrix
G. Generatrix
F, F′ Focal point
E. Ellipse
L_{f1} First focal line
L_{f2} Second focal line
P1, P2 Parallel lines
R, R′ Ray

What is claimed is:

1. An illumination apparatus, comprising:
at least one light source arranged along a first line; and
a cylindrical elliptical reflective surface substantially parallel to the first line for directing light from the at least one light source toward a scanned surface, the cylindrical elliptical reflective surface adapted to form a line of light along the scanned surface.

2. The illumination apparatus of claim 1, wherein:
the cylindrical elliptical reflective surface includes a generatrix substantially parallel to the first line; and
a directrix of the cylindrical elliptical reflective surface substantially follows the curvature of a segment of an ellipse, wherein the first line substantially intersects a focal point of the elliptical directrix.

3. The illumination apparatus of claim 1 further comprising a filter disposed to condition the light reflected from the cylindrical elliptical reflective surface.

4. The illumination apparatus of claim 3 wherein the filter conditions the irradiance profile of the line of light.

5. The illumination apparatus of claim 1 wherein the at least one light source is a laser diode.

6. The illumination apparatus of claim 1 wherein the at least one light source is a light emitting diode.

7. An illumination apparatus of an optical scanning system, comprising:
at least one light source arranged along a first line; and
a cylindrical elliptical reflective surface for directing light from the at least one light source toward a scanned surface, the cylindrical elliptical reflective surface adapted to form a line of light along the scanned surface, wherein the cylindrical elliptical reflective surface includes:
a generatrix substantially parallel to the first line; and
a directrix that substantially follows the curvature of a segment of an ellipse, wherein the first line substantially intersecting a focal point of the elliptical directrix.

8. The illumination apparatus of claim 7 further comprising a filter disposed to condition the light reflected from the cylindrical elliptical reflective surface, wherein the filter conditions the irradiance profile of the line of light.

9. A reading apparatus for obtaining a line of image data stored on a surface, the reading apparatus comprising:
a radiation source for directing a line of stimulating radiation onto a surface of a stimulable image carrier to generate a line of image-bearing radiation, the radiation source comprising:
i) at least one light source arranged along a first line; and
ii) a cylindrical elliptical reflective surface substantially parallel to the first line for directing light from the at least one light source toward the surface, the cylindrical elliptical reflective surface adapted to form the line of stimulating radiation along the surface;
a sensing head for obtaining image data from a line of image-bearing radiation excited from the image carrier by the line of stimulating radiation; and
an image processor for accepting the image data obtained from the sensing head and forming the line of image data therefrom.

10. The reading apparatus according to claim 9 wherein the sensing head comprises a charge-coupled device.

11. The reading apparatus according to claim 9 wherein the at least one light source emits laser radiation.

12. The reading apparatus according to claim 9 wherein the at least one light source is a light emitting diode.

13. The reading apparatus according to claim 9 wherein:
the cylindrical elliptical reflective surface has a generatrix substantially parallel to the first line; and
a directrix of the cylindrical elliptical reflective surface substantially follows the curvature of a segment of an ellipse, wherein the first line substantially intersects a focal point of the elliptical directrix.

14. The reading apparatus according to claim 9 further comprising a filter for conditioning the irradiance profile of the line of stimulating radiation.

15. The reading apparatus according to claim 9 wherein the sensing head has a plurality of channels, each channel sensing a segment of the line of image-bearing radiation.

16. A method for providing a linear illumination, the method comprising the steps of:
providing at least one light source along a first line; and
providing a cylindrical elliptical reflective surface substantially parallel to the first line for directing light from the at least one light source toward a scanned surface, wherein the first line substantially intersects a focal point of an ellipse that comprises a directrix of the cylindrical elliptical reflective surface, the cylindrical elliptical reflective surface forming a line of light along the scanned surface thereby.

17. The method according to claim 16 wherein the step of providing at least one light source along a first line is accomplished by positioning a laser diode along the first line.

18. The method according to claim 16 further comprising the step of conditioning the line of light by providing a filter in the path of reflected light.

19. A method of adjusting a line width and a widthwise irradiance profile across a line formed by a linear illuminator, the method comprising the steps of:
disposing at least one light source along a first line; and
disposing a cylindrical elliptical reflective surface substantially parallel to the first line for directing light from the at least one light source toward a scanned surface, wherein the cylindrical elliptical reflective surface has a first and second focal line substantially parallel with the first line and wherein the first line is not coincident with either the first or second focal lines.
